(19) United States
(12) Patent Application Publication
(10) Pub. No.: US 2006/0070033 A1
(43) Pub. Date: Mar. 30, 2006

(54) System and method for analyzing effects of configuration changes in a complex system

(75) Inventors: Jeffrey E. Care, Morrisville, NC (US); Erik J. Burckart, Raleigh, NC (US); Ryan L. Urquhart, Durham, NC (US); David J. Schell, Raleigh, NC (US)

Correspondence Address: HOFFMAN, WARNICK & D'ALESSANDRO LLC, 75 STATE ST, 14 FL, ALBANY, NY, 12207, US

(73) Assignee: International Business Machines Corporation, Armonk, NY (US)

(21) Appl. No.: 10/950,250

(22) Filed: Sep. 24, 2004

(51) Int. Cl. G06F 9/44

(52) U.S. Cl. 717/124

(57) ABSTRACT

A system and method for analyzing configuration changes made to a computerized system. A configuration analysis system is provided that includes: a system for generating characteristic data for a captured set of configuration changes; an analyzer repository for storing a set of analyzers configured to analyze configuration changes, wherein each analyzer is associated with a rule relating to at least one predefined configuration change; and an analyzer selection system for selecting at least one analyzer from the analyzer repository by comparing the characteristic data with the rules of the associated analyzers.

### BACKGROUND OF THE INVENTION

1. Field of the Invention

The present invention relates generally to analyzing effects of a system state, and more specifically relates to a system and method of analyzing the effects of configuration changes in a complex system, such as a server program.

2. Related Art

In complex computing environments in which many different software processes run and interact, changes to the operational state of the system may cause side effects that are unknown or unobvious to the people or processes making the changes. Such changes may occur, for instance, whenever a system administrator or the like implements configuration changes to the system. Depending on the ways in which various software processes interact, the end result of one or more changes could include degraded performance or even a system crash.

For example, in a complex application server environment, a first software process may allow the system administrator to configure time-out parameters due to inactivity, while a second software process allow configuration of allocation parameters relating to persistent http requests allowed per socket. Depending on the settings of both, a seemingly innocuous change to one of the parameters could significantly degrade performance, e.g., if both the time-out and number of allowed sockets exceed a threshold, the overall performance of the server may suffer.

Unfortunately, current analysis systems are able to perform only limited analysis and validation of such changes, e.g., usually to verify the new configuration values fit a certain format, fall in a certain range, etc. While these current systems provide useful and necessary functions, they provide little or no information about the true effect that changes may cause to the system.

Accordingly, a need exists for an analysis system that can provide better information about the effects of changes made to the operational state of the system.

### SUMMARY OF THE INVENTION

The present invention address the above-mentioned problems, as well as others, by providing a system, method and program product for analyzing configuration changes by utilizing one or more analyzers selected from a repository of analyzers. In a first aspect, the invention provides a configuration analysis system for analyzing configuration changes made to a computerized system, comprising: a system for generating characteristic data based on a captured set of configuration changes; an analyzer repository for storing a set of analyzers capable of analyzing configuration changes, wherein each analyzer has an associated rule defining at least one predefined configuration change; and an analyzer selection system for selecting at least one analyzer from the analyzer repository by comparing the characteristic data with the associated rules of the analyzers.

In a second aspect, the invention provides a program product stored on a recordable medium for analyzing configuration changes made to a computerized system, comprising: program code configured for generating characteristic data for a captured set of configuration changes; program code configured for registering a set of analyzers capable of analyzing configuration changes, wherein each registered analyzer has an associated rule that defines at least one predefined configuration change; and program code configured for selecting at least one analyzer from the analyzer repository by comparing the characteristic data with the associated rules of the analyzers.

In a third aspect, the invention provides a method for analyzing configuration changes made to a computerized system, comprising: registering a set of analyzers each capable of analyzing configuration changes, wherein each analyzer is associated with a rule relating to at least one predefined configuration change; generating characteristic data for a captured set of configuration changes; selecting at least one analyzer from the analyzer repository by comparing the characteristic data with the rules of the associated analyzers; and executing selected analyzers against the captured set of configuration changes.

In a fourth aspect, the invention provides a method for deploying a configuration analysis system for analyzing configuration changes made to a computerized system, comprising: providing a computer infrastructure being operable to: generate characteristic data for a captured set of configuration changes; register a set of analyzers capable of analyzing configuration changes, wherein each analyzer is associated with a rule relating to at least one predefined configuration change; and select at least one analyzer from the analyzer repository by comparing the characteristic data with the rules of the associated analyzers.

In a fifth aspect, the invention provides computer software embodied in a propagated signal for analyzing configuration changes made to a computerized system, comprising: the computer software comprising instruction to cause a computer system to perform the following functions: generate characteristic data for a captured set of configuration changes; register a set of analyzers designed to analyze configuration changes, wherein each analyzer is associated with a rule relating to at least one predefined configuration change; and select at least one analyzer from the analyzer repository by comparing the characteristic data with the rules of the associated analyzers.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a block diagram of a computerized implemented system having a configuration analysis system according to the present invention.

FIG. 2 depicts a configuration analysis system according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

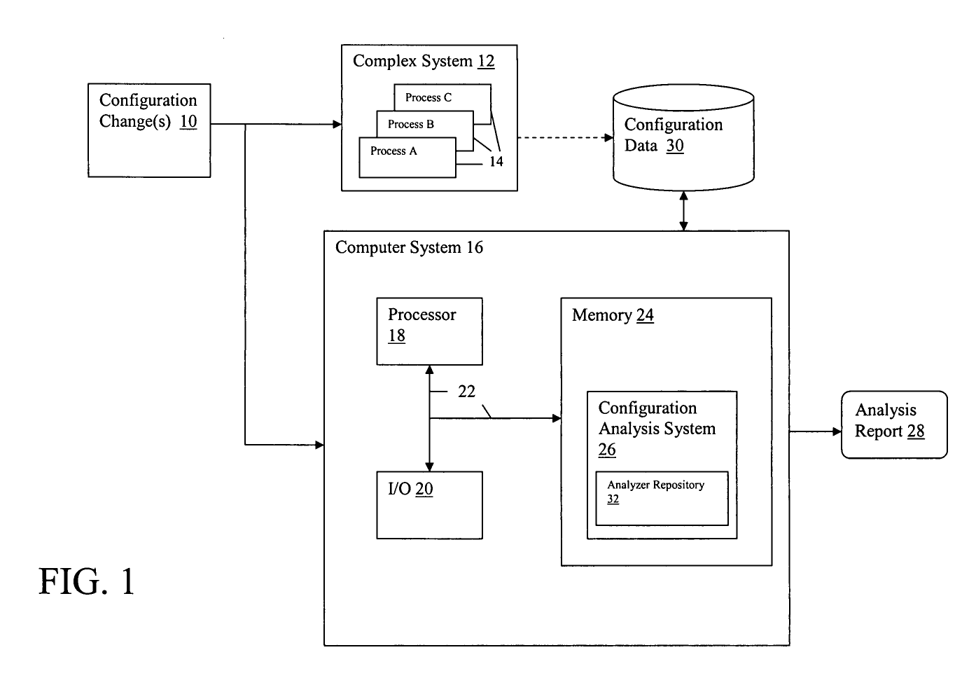

Referring now to the figures, FIG. 1 depicts a general overview of a computerized implementation of a configuration analysis system 26 that provides an analysis report 28 of the impact of configuration change(s) 10 made to complex system 12. Configuration change(s) 10 may comprise a set of (i.e., one or more) changes made to the operational state of the complex system 12, e.g., changing a value, constraint, range, etc., of a timing, memory or processing parameter. Configuration change(s) 10 may come from any source including, e.g., a system administrator, an end user, the complex system 12 itself, another system, etc. Complex system 12 may comprise any type of computerized system in which multiple processes 14 run simultaneously and potentially interact with each other. For example, complex system 12 may comprise an application server, a file server, an operating system, a computer system, an enterprise software application, etc.

As can be seen, when configuration change(s) 10 are made to complex system 12, the changes are also captured by computer system 16. Computer system 16 may be integrated with or exist separately from complex system 12. Computer system 16 is intended to represent any type of computerized device such as a desktop computer, a laptop computer, a workstation, a hand held device, a server, a client, etc. Moreover, it should be appreciated that the teachings of the present invention could be implemented on a stand-alone computer or over a network. For example, computer system 16 could comprise a server that interacts with a client (not shown) over a network such as the Internet, a local area network (LAN), a wide area network (WAN), a virtual private network (VPN), etc. In such a case, a direct hardwired connection (e.g., serial port), or an addressable connection with computer system 16 could be implemented. The addressable connection may utilize any combination of wireline and/or wireless transmission methods. Moreover, conventional network connectivity, such as Token Ring, Ethernet, WiFi or other conventional communications standards could be used. Still yet, connectivity could be provided by conventional IP-based protocol.

As also depicted, computer system 16 generally comprises processing unit 18, memory 24, bus 22, input/output (I/O) interfaces 20, and external devices/resources (not shown). Processing unit 18 may comprise a single processing unit, or be distributed across one or more processing units in one or more locations, e.g., on a client and server. Memory 24 may comprise any known type of data storage and/or transmission media, including magnetic media, optical media, random access memory (RAM), read-only memory (ROM), a data cache, a data object, etc. Moreover, similar to processing unit 18, memory 24 may reside at a single physical location, comprising one or more types of data storage, or be distributed across a plurality of physical systems in various forms.

I/O interfaces 20 may comprise any system for exchanging information to/from an external source. External devices/resources may comprise any known type of external device, including speakers, a CRT, LED screen, hand-held device, keyboard, mouse, voice recognition system, speech output system, printer, monitor/display, facsimile, pager, etc. Bus 22 provides a communication link between each of the components in computer system 16 and likewise may comprise any known type of transmission link, including electrical, optical, wireless, etc. Although not shown, additional components, such as cache memory, communication systems, system software, etc., may be incorporated into computer system 16.

Also shown is a database of configuration data 30 that reflects the current configuration of complex system 12. The database may include any system (e.g., a relational database, file system, etc.) capable of providing storage for information under the present invention. Such information could be derived directly from complex system 12, or be derived, created or stored in any other manner, e.g., as a result of recording historical changes, etc. As such, the database of configuration data 30 could include one or more storage devices, such as a magnetic disk drive or an optical disk drive. In another embodiment, the database may include data distributed across, for example, a local area network (LAN), wide area network (WAN) or a storage area network (SAN) (not shown).

Stored in memory 24 as a program product is configuration analysis system 26, which analyzes configuration change(s) 10 and outputs an analysis report 28 that details the potential side effects or impact of the configuration change(s) 10 to complex system 12. Configuration analysis system 26 includes an analyzer repository 32, wherein one or more analyzers may be registered for use. As described in further detail below, different analyzers can be run in response to the particular configuration change(s) 10 being made.

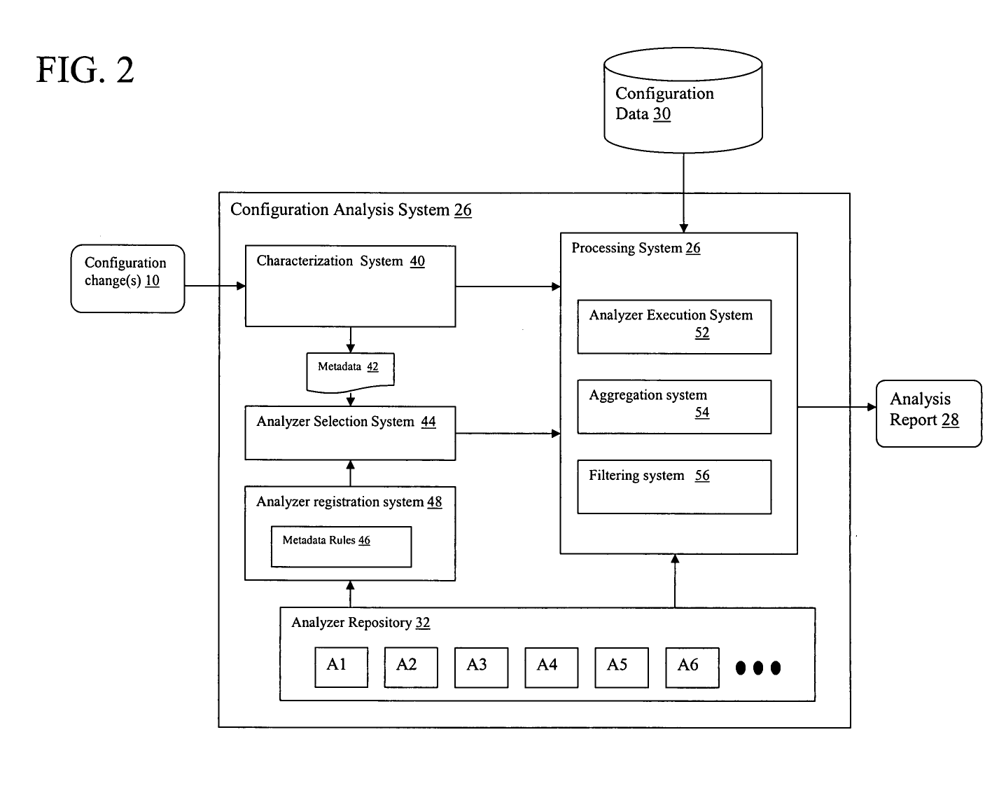

Referring now to FIG. 2, a more detailed overview of configuration analysis system 26 is shown. Configuration analysis system 26 includes a characterization system 40 that characterizes the inputted configuration change(s) 10. In this illustrative embodiment, characterization system 40 generates a set of metadata 42 that characterizes the associated change(s) 10. Metadata 42 may be generated in any format, such as XML, a flat file, etc. For example, a metadata statement characterizing a timeout change may appear as: <TimeoutData persistentTimeout=“30” readTimeout=“10” writeTimeout=“10”/>.

Also included in configuration analysis system 26 is analyzer repository 32, which includes a set of analyzers (A1, A2, A3 . . . ), which are utilized as part of the analysis process. An analyzer registration system 48 is utilized to register analyzers stored in the analyzer repository 32. For example, analyzer registration system 48 may collect an associated metadata rule 46 for each analyzer as part of the registration process. Each such rule relates to (i.e., defines) a specific type of configuration change (or changes). For instance, an analyzer may include a rule that relates to a “time out” condition.

Analyzer selection system 44 selects one or more analyzer (A1, A2, A3 . . . ) to be used during the analysis process by matching the characterization metadata 42 with the metadata rules 46 of the registered analyzers. For example, suppose the characterization system 40 identified changes by data type (e.g., a fully qualified Java class name) and operation (e.g., create, update, delete, etc.). The analyzer repository 32 could have analyzers registered for a combination of these two pieces of metadata, e.g., creating a javax.naming.InitialContext, updating a java.lang.Thread. Note that multiple analyzers can be registered with identical metadata rules 46.

Once the selections are made, they are passed to analyzer processing system 26, which carries out the actual analysis. In this illustrative embodiment, analyzer processing system 26 includes an execution system 52 for running the selected analyzers against the configuration change(s) 10. The execution system 52 can input the configuration data 30 representing the complex system 12 when executing the analyzers. Thus, each analyzer can examine the entire state of the complex system 12 to determine any potentially negative side-effects of the configuration change(s) 10.

Each analyzer that is executed may output an analysis message or set of messages. Each message may include metadata that can be filtered or categorized. Thus, once all of the selected analyzers have been run and their output collected, aggregation system 54 can be utilized to further process the output, including, e.g., combining results, examining the output for redundant messages, formatting of the output, etc.

Finally, a filtering system 56 may be utilized to filter out unwanted messages, e.g., as specified by the end user. The resulting analysis report 28 is then outputted and presented to the user.

An example may involve a server configuration of (1) an I/O inactivity timeout, and (2) the maximum number of persistent http requests on a single socket. If an administrator originally configured each of these pieces in different places, and then changed the inactivity timeout, an http analyzer for the http piece of code may have registered an interest in the timeout. For instance, when the http analyzer is run, the http analyzer may grab the maximum number of persistent requests from the configuration data 30, and conclude that both configuration values (i.e., the maximum number of persistent requests and the timeout value) exceeded some threshold.

The combination of the two configuration values may cause the http analyzer to return a performance based warning message that the combination of these two values may allow clients to use excessive resources of the server. Such a message would be recorded, checked to ensure that there were no duplicates, filtered based on properties of the configuration analysis system 26, and then outputted to the administrator.

It is understood that this is but one of many possible implementations. Other examples may include the configuration of a system and an analysis to ensure that there was no single point of failure or security risk in the complex system 12.

It should also be understood that configuration analysis system 26 may be utilized to analyze “obvious and non-obvious dependencies” within a complex configuration model. An obvious dependency would be one such as the case where X and Y are attributes of Z. In this case, one analyzer might register for any changes to Z, and therefore be utilized for changes to X and Y. A non-obvious dependency however cannot be easily seen through modeling. For instance, consider a dependency from A to X where A is an attribute of B, which is an attribute of C, which is an attribute of D, and D is one of many objects under E. Z, which has X and Y attributes, is also under E. There is no obvious dependency from A to X but there may be some logical dependency that the author of the configuration system knows needs evaluation. Accordingly an analyzer could be provided for all changes to X or A.

It should be appreciated that the teachings of the present invention could be offered as a business method on a subscription or fee basis. For example, configuration analysis system 26 could be created, maintained, supported and/or deployed by a service provider that offers the functions described herein for customers.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A configuration analysis system for analyzing configuration changes made to a computerized system, comprising:
a system for generating characteristic data based on a captured set of configuration changes;
an analyzer repository for storing a set of analyzers capable of analyzing configuration changes, wherein each analyzer has an associated rule defining at least one predefined configuration change; and
an analyzer selection system for selecting at least one analyzer from the analyzer repository by comparing the characteristic data with the associated rules of the analyzers.

2. The configuration analysis system of claim 1, further comprising a registration system for registering analyzers and their associated rules.

3. The configuration analysis system of claim 1, further comprising a processing system for executing selected analyzers against the captured set of configuration changes.

4. The configuration analysis system of claim 3, wherein the processing system has access to configuration data for the computerized system.

5. The configuration analysis system of claim 3, wherein the processing system includes an aggregation system for aggregating results of a plurality of analyzers.

6. The configuration analysis system of claim 3, wherein the processing system includes a filtering system for filtering results generated by one or more analyzers.

7. The configuration analysis system of claim 3, wherein the processing system outputs an analysis report listing potential side effects of the configuration changes to the computerized system.

8. The configuration analysis system of claim 1, wherein the computerized system comprises an application server.

9. A program product stored on a recordable medium for analyzing configuration changes made to a computerized system, comprising:
program code configured for generating characteristic data for a captured set of configuration changes;
program code configured for registering a set of analyzers capable of analyzing configuration changes, wherein each registered analyzer has an associated rule that defines at least one predefined configuration change; and
program code configured for selecting at least one analyzer from the analyzer repository by comparing the characteristic data with the associated rules of the analyzers.

10. The program product of claim 9, further comprising program code configured for executing selected analyzers against the captured set of configuration changes.

11. The program product of claim 10, further comprising program code configured for accessing configuration data for the computerized system.

12. The program product of claim 10, further comprising program code configured for aggregating results of a plurality of analyzers.

13. The program product of claim 10, further comprising program code configured for filtering results generated by one or more analyzers.

14. The program product of claim 10, further comprising program code configured for outputting an analysis report listing potential side effects of the configuration changes to the computerized system.

15. The program product of claim 10, wherein the computerized system comprises an application server.

16. A method for analyzing configuration changes made to a computerized system, comprising:
registering a set of analyzers each capable of analyzing configuration changes, wherein each analyzer is associated with a rule relating to at least one predefined configuration change;
generating characteristic data for a captured set of configuration changes;
selecting at least one analyzer from the analyzer repository by comparing the characteristic data with the rules of the associated analyzers; and
executing selected analyzers against the captured set of configuration changes.

17. The method of claim 16, wherein the execution step includes the step of accessing configuration data of the computerized system.

18. The method of claim 16, including the further step of aggregating results of a plurality of analyzers.

19. The method of claim 16, including the further step of filtering results generated by one or more analyzers.

20. The method of claim 16, including the further step of outputting an analysis report listing potential side effects of the configuration changes to the computerized system.

21. The method of claim 16, wherein the computerized system comprises an application server.

22. A method for deploying a configuration analysis system for analyzing configuration changes made to a computerized system, comprising:
providing a computer infrastructure being operable to:
generate characteristic data for a captured set of configuration changes;
register a set of analyzers capable of analyzing configuration changes, wherein each analyzer is associated with a rule relating to at least one predefined configuration change; and
select at least one analyzer from the analyzer repository by comparing the characteristic data with the rules of the associated analyzers.

23. Computer software embodied in a propagated signal for analyzing configuration changes made to a computerized system, comprising:
the computer software comprising instruction to cause a computer system to perform the following functions:
generate characteristic data for a captured set of configuration changes;
register a set of analyzers designed to analyze configuration changes, wherein each analyzer is associated with a rule relating to at least one predefined configuration change; and
select at least one analyzer from the analyzer repository by comparing the characteristic data with the rules of the associated analyzers.
